(19) United States
(12) Patent Application Publication
(10) Pub. No.: US 2025/0014477 A1
(43) Pub. Date: Jan. 9, 2025

(54) Action-based Movement Therapy Optimization

(71) Applicant: The Cube Enterprises Corp., Raleigh, NC (US)

(72) Inventor: Joseph Kleman, Raleigh, NC (US)

(21) Appl. No.: 18/348,788

(22) Filed: Jul. 7, 2023

(51) Int. Cl. G09B 19/00

(52) U.S. Cl. CPC G09B 19/003

(57) ABSTRACT

This document presents a system and method for utilizing a device defining a cubic volume to assist a user to achieve a therapeutic goal. The cubic volume is defined by a solid frame to which suspension cables are attached that cross portions of the cubic volume and where each suspension cable has one or more balls of various colors and sizes emplaced along the suspension cable. The user enters or is positioned adjacent to the solid frame such that the user interacts with the cables and balls to achieve a therapeutic result based upon suggestions by a facilitator and the user following the instructions and incorporating self-initiated movement.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

It is well understood that users who are seeking professional help to achieve a goal or discover a solution to a mental health issue or problem will meet with one or more professional therapists or medical health practitioners to find such help. Professional therapists and medical practitioners have an array of tools at their disposal to plan activities and design therapeutic sessions to meet the goals and needs of their patients.

Professional guidance is important, as are physical and therapeutic devices, to assist the professional therapist or medical practitioner in meeting the needs of the users seeking their help. However, providing the user with the ability to not only design their own activities and therapeutic or play sessions but also conduct their actions with little or no guidance on what activities to perform is often lacking in such sessions.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of the performance apparatus consistent with certain embodiments of the present invention.

FIG. 2 is a view of the connection detail of the action ball suspension cables consistent with certain embodiments of the present invention.

FIG. 3A is an exploded view of an action ball consistent with certain embodiments of the present invention.

FIG. 3B is a view of action balls consistent with certain embodiments of the present invention.

FIG. 4 is a flow diagram for a therapy session utilizing the exercise performance apparatus consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

In a non-limiting example, the innovation utilizes an exercise matrix device as a performance apparatus having a base frame that is configured in a cube formation. The cube formation and adjacent perimeter outlines the therapy performance boundary of the apparatus, where the boundary of the apparatus may encompass the entirety of a room or any portion thereof that is suitable for therapeutic or play usage. In this embodiment, the cubic shaped base frame may have a plurality of suspension cables which are connected to a side portion of the cubic shaped base frame. Each suspension cable may be positioned to stretch from one side portion of the cubic shaped base frame to an opposite side member of the cube shaped base frame. Any suspension cable may be positioned to be connected in a straight line from one side to an opposing side of the cube shaped base frame, forming a straight side configuration. Any suspension cable may alternatively be positioned to be connected from one side of the cubic shaped base frame to an opposite side member that is not in line with the first connected side such that the suspension cable passes through the cubic volume, from one side to the other, that is formed by the cubic shaped base frame of the exercise matrix device. A pre-determined number of the straight line connected suspension cables and the opposing side connected suspension cables may be connected in a matrix of cables passing through and along the sides of the cubic shaped base frame to form an exercise matrix within the exercise matrix device.

In an embodiment, each connected suspension cable may be configured with one or more solid elements, such as balls. However, the use of balls may in no way be construed as limiting as the suspension cable may have balls, blocks, oval beads, or other solid shapes configured to be used with the exercise matrix device and configured to be used in the exercise matrix device. In a non-limiting example, the balls, or other solid elements, may be various colors and sizes, but are each of sufficient diameter to permit the suspension cable to pass through any ball or solid element. The suspension cable may be configured to pass through each solid element, such as a ball, such that the one or more balls on each suspension cable may be slideably moved along the suspension cable in each direction to the limit the ball may reach, which may be to the terminus of the connection point where the suspension cable connects to the cubic shaped base frame, or to the point where another ball on the same suspension cable restricts the movement along the suspension cable of the ball being moved. In an embodiment, a single ball may be placed such that more than one suspension cable passes through a single ball. In this configuration, a single ball with multiple suspension cables passing through the single ball may form a distinct connection point as a nexus. Moving balls along any cable and interacting with balls in movement and balls in a nexus contribute to the therapeutic process.

In the exercise matrix device the balls, or other solid elements, may be colored in primary color patterns. The primary color patterns my play a role in regulating the part of the brain associated with fear and anxiety, the amygdala, and, when used in a therapeutic or play setting, may instill trust, playfulness and creativity in the mind of the user when involved in therapy or play using the exercise matrix device. This regulation role may be fostered by the use in the structure of soft surfaces that do not trigger the activation of the amygdala as compared with hard lines and pointed edges that may be used in other therapy or play scenarios. In an embodiment, in this matrix configuration the exercise matrix device may then be utilized by a client to perform one or more therapeutic or play activities, actions, motions, or movements in furtherance of a therapeutic, relaxing, or challenging process to achieve a goal set by the client.

In an embodiment, the exercise matrix device may be utilized by a client to perform actions, activities, motions, or movements from within the boundaries of a frame of the exercise matrix device, where the frame is constructed to encompass a volume defined by a cubic, oval, rectangular, square, or other volumetric solid frame structure. In a non-limiting example, and for purposes of discussion, the frame of the exercise matrix device used in the described embodiment will be a cubic frame encompassing a cubic volume where that volume may be the entirety of a room or any portion of a room. As an initial step, the client may enter within the matrix space that is bounded by the cubic frame of the exercise matrix device. An instructor, therapist, family member, or medical professional may be positioned outside of the exercise matrix device to counsel and assist with the therapeutic activities, action, motions, or movements in furtherance of the therapeutic process, which may be a directed, instruction process or a play process. Additional movement may be performed within the cubic volume defined by the cubic frame, or may encompass movement or actions that are performed from outside that bounded cubic volume but still have the client interacting with the solid elements, cables, or other elements of the exercise matrix device.

In an embodiment, the therapeutic process may begin with the phrase “there are no rules, there are no rights/wrongs, and you can do anything you want”. The participant or client may be encouraged to start by receiving a basic command from the facilitator, who may be an instructor, therapist, family member or medical professional, such as “touch the red balls with your right hand and blue balls with your left hand”. From that point on, the facilitator must be fully attuned to the movements, facial features, hesitations, and other actions, comments, and/or facial expressions of the participant. As the facilitator is watching the participant go through the commands the facilitator is determining, in the facilitator's judgement, how the participant is responding to the cues, and less about the accuracy of the commands given. As the facilitator observes the client as they move, the facilitator may increase or decrease the difficulty of the instructions or commands given based on the responses the participant is giving back. In a non-limiting example, if the participant is responding well to the current instruction the participant may be judged to have achieved the response for this command or instruction and may determine that the participant is ready for more complex or more directed commands or instruction. In this case, the facilitator may then progress to “now when you touch red, say ‘blue’ and when you touch blue, say ‘red’”. The more complex or more finely directed instructions and commands are used to stress the participant just enough to place the participant in a slightly uncomfortable stance or mental space while the participant is still able to complete the task given to them.

As part of the process the facilitator will be constantly giving feedback to the participant by saying “good job” or “you're doing great” to bolster the confidence of the participant in the process. Most people want and/or need to know that they are responding and performing properly to accomplish the instructions given, despite there not being any defined “correct” way of complying with the instructions or commands given by the facilitator. Occasionally the facilitator may find it necessary to back the participant down to a “lower level” by telling the participant to ignore and/or no longer process the previously given instructions and commands and continue the session with entirely new instructions or commands. There are many ways of increasing or decreasing the difficulty, but the beauty of the therapy comes from the interaction between the facilitator and client through the use of Active and Perceptive Inference.

Active and Perceptive Inference is defined as moments when the facilitator and participant are inferring from each other's perception what is being asked of them and how the participant is responding to the interaction. The action of the participant may match or not match what the facilitator perceived the participant would do. If the action of the participant does not match the facilitator's perceived response a difference is triggered and the actions and suggestions change.

Perception is based on physical features and felt through co-regulation where the facilitator and the participant's nervous systems are testing one another. This testing is important to recognize. The facilitator subconsciously has the power to adjust a participant's action and game activity by how the facilitator perceive the participant is feeling on that day, or the tone in which the instructions are being given. Each time actions or game play activities are suggested with the same facilitator and participant(s) the comfort level between them increases and the potential to penetrate deeper into the nervous system is unlocked. This deepening penetration into the participant's nervous system permits the therapeutic device and process continues to help heal participant trauma at deeper and deeper levels.

In an embodiment, after the facilitator increases the difficulty of the instructions and commands to be followed to a level such that the participant is challenged, but continues to be able to successfully follow the instructions and commands, the facilitator may tend to see the participant enter a flow-state where they begin moving without fear or hesitation. This is the state where the analytical brain gets out of the way and the participant is able to just have fun and respond to the objects and positions that are in front of them. It is at this point in the therapeutic process that the facilitator will want to keep the participant in this free-flowing reactive state for as long as possible. The facilitator may then provide instructions and commands that relate what the facilitator has observed with regards to movements and actions in the OmniCube to the participant's work, family, play-time, leisure activities, and other aspects of the participant's life and show them how they acted out their real life in the OmniCube through the actions, motions, expressions, positions, and other activities while engaged with the OmniCube. The facilitator may then also offer suggestions on how the participant might be able to make adjustments in their life to achieve an expressed desire, goal, or position based on the facilitator's observations.

In an alternative embodiment, a user may initiate a self-guided session where the user may listen to a session designed to meet the user's goal that has been pre-recorded by a trained therapist or other medical professional. The self-guided session may be performed at home or in a location separate from the therapist or other medical professional as a facilitator when the facilitator is not present. The self-guided option permits the user to achieve desired results even when no facilitator is present. The user may be also to self-select the level that they believe is the correct level of difficulty for each session. The pre-recorded session instructions may still be focused on achieving a desired outcome for the session. In non-limiting examples, pre-recorded session instructions may be available to assist with therapies that are specific to ADHD participants by incorporating fast movements, or to a “flow state” participant that is simply falling into various movements to achieve a peaceful conclusion to the therapy session.

In a non-limiting example, the facilitator may design a 10-20 minute protocol of commands, suggestions, actions, and motions utilizing the OmniCube exercise matrix device with an expectation of achieving a pre-established or previously expressed goal for the session. However, the time span should in no way be considered limiting as other sessions may require a different time span.

In an embodiment, the therapy apparatus may be provided with a networked computer connection to establish and operate additional therapeutic and play actions utilizing Augmented Reality (AR) and/or Virtual Reality (VR) environments. The AR and/or VR environments would utilize the therapy apparatus framework to establish the exterior boundaries of the area in which users would interact with the therapy apparatus. In an AR implementation, the balls may be filled with sound and light emitters that will also be tied into a central networked computer server. The server may be able to generate automatic programs such as “touch right hand to green and left elbow to yellow” so users may perform therapeutic or play activities alone and without outside assistance.

The AR implementation will provide each user with a login and the computer server will remember each user, what outcomes the user is setting as a goal or accomplishing, and what level the user may have completed in a previous therapeutic or play session within the AR level apparatus. The AR implementation may increase the difficulty level of tasks to be performed. This difficulty increase may be configured to incrementally increase task difficulty at around a 4% increase so the ratio of the level of difficulty to skill stays in a range where the participant is able to stay in flow and not be overwhelmed.

The AR implementation may also add touch sensors to the balls to collect information on user accuracy and reaction time when interacting with the balls having touch sensors installed within. This information will be vital to the assessment of user's progress when interacting with the process of using the therapeutic apparatus. The collected information will provide the data and metrics that may contribute to an assessment of a user as belonging to a certain personality type; ie “we know that people who achieve this type of score tend to be problem solvers and free thinkers” vs. “this type of score tends to be more seen in task driven people”.

Equipping the balls with sensors, color and sound emitters, and tying each ball to a central computer through electronic data communication capabilities such as NFC protocols, the apparatus may be able to harness the power of AI and/or Machine Learning systems to create therapeutic or play activities that may continue to challenge the participant indefinitely.

In an embodiment, the therapeutic apparatus may be connected to the networked computer server that enables the creation of a virtual reality platform in which a person will place the headset on and be instantly brought into a volumetric space which looks very similar to the existing form of the therapeutic apparatus. The virtual reality implementation may allow a user who is experiencing a mental health crisis in their home to get the nervous system regulation assistance they need to go about their day. The VR implementation may also provide the ability to virtually link practitioners to watch, evaluate, and administer therapeutic or play sessions remotely.

With the virtual reality version, the AI component will still be utilized if a practitioner is not available, or to add some variability that the practitioner may not be able to come up with on their own. The AI component will be able to allow endless variations and skill levels to progress to meet the user needs while keeping each user in a flow state to grow and/or be used therapeutically to meet an established and pre-configured goal.

At the end of the protocol implemented within each session, whether administered in person, in an AR implementation, or in a VR implementation, the result of a therapeutic or play session is a sense of calm, happy, energized, enthusiastic, flow-state, spontaneous smiling, acceptance of who they are and how they move and think that is in keeping with the pre-established or previously expressed goal for the session.

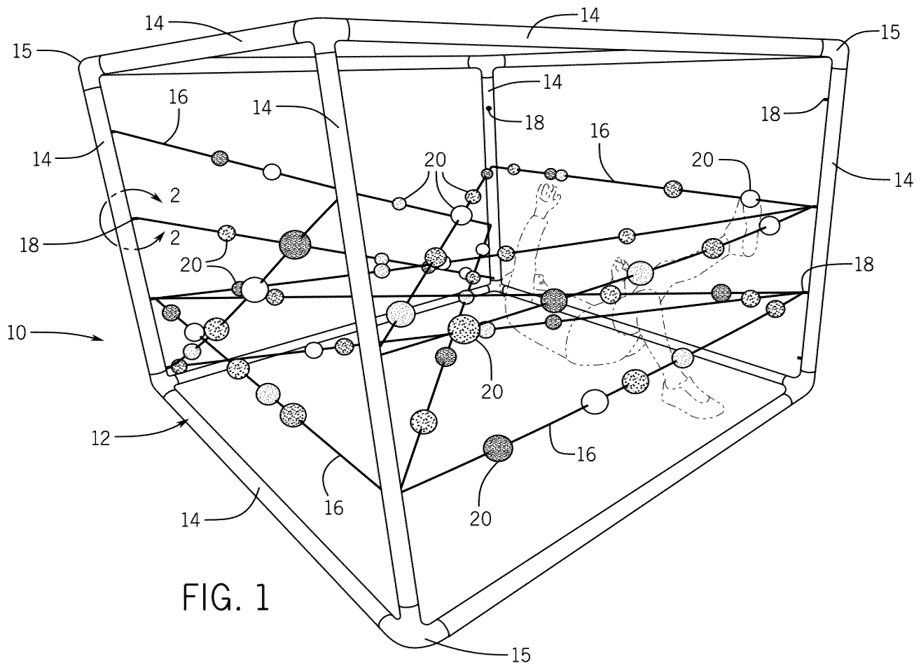

Turning now to FIG. 1, this figure presents a view of the exercise matrix apparatus consistent with certain embodiments of the present invention. In an exemplary embodiment, the apparatus comprises an exercise matrix device 10, shown here in perspective view, having a cubic frame 12. The cubic frame 12 may be composed of any material, such as plastic piping, PVC, metal piping, wood, or any other material that may be formed into frame members having a circular cross-section. The cubic frame 12 may be constructed from a plurality of lineal frame members 14 of various lengths with the lineal frame members 14 connected at the corners of a cubic framed volume by corner members 15 of sufficient diameter to form a solid connection with each lineal frame member 14. The cubic volume outlined by the frame members of the cubic frame 12 may be crossed by a plurality of suspension cables or cords 16. The suspension cables 16 may cross the cubic volume in a linear orientation passing in a straight line directly from one side of the cubic volume to another, or may cross the cubic volume in a diagonal orientation, or may be oriented vertically, again crossing from one side of the cubic frame to another side of the cubic frame. The plurality of suspension cables may be connected in any or all of the orientations herein described to create a pre-determined setup for the cable configuration to achieve one or more therapeutic goals. In an embodiment, each of the suspension cables 16 may be configured with one or more balls 20. The balls 20 may consist of different sized and different colored balls with a suspension cable 16 passing through each ball such that the ball may be slideably moved along the suspension cable 16 in either direction under the impetus of a client. As previously discussed, a client may be placed within the cubic volume defined by the frame 12 of the exercise matrix device 10, or the client may be positioned partially within and outside of the frame 12, or the client may be positioned outside of the cubic volume defined by the frame 12, or any mixture of these positions based upon the instructions of the facilitator or the independent responsive motions of the client.

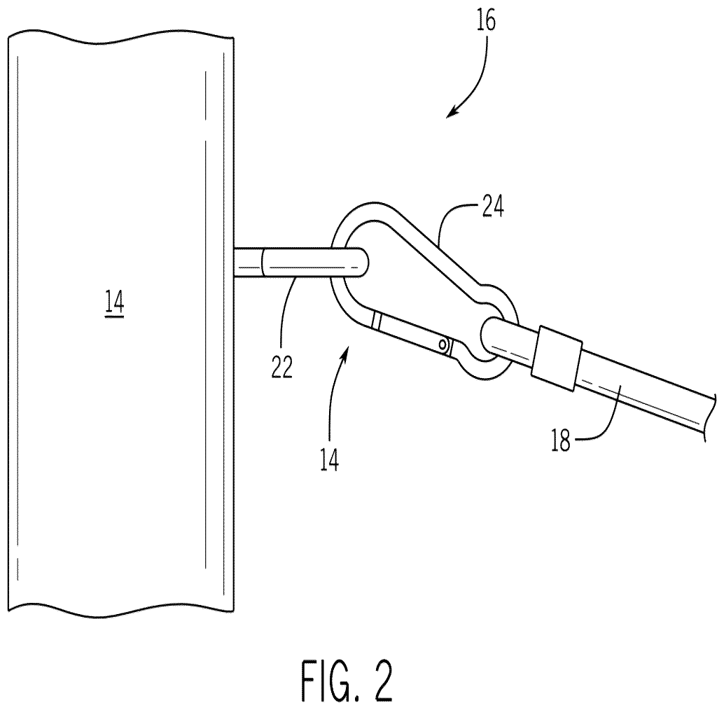

Turning now to FIG. 2, this figure presents a view of the connection detail of the action ball suspension cables consistent with certain embodiments of the present invention. In an exemplary embodiment, the figure presents the quick disconnect attachment element 16 for the suspension cables 18 to the frame lineal elements 14. Each frame lineal element 14 has installed at various heights and positions a plurality of eye hooks 22. Each suspension cable 18 has a snap clip 24 forming the proximal and distal ends of the suspension cable 18. The snap clips 24 permit either end of the suspension cable 16 to be attached to a snap clip 24 at a particular position, or permits the detachment and relocation of the end of a suspension cable 18 to a different snap clip 24 to reconfigure the suspension cables 16 within the cubic volume of the cubic frame 12 as required to support the pre-established or previously expressed goal for the therapy session.

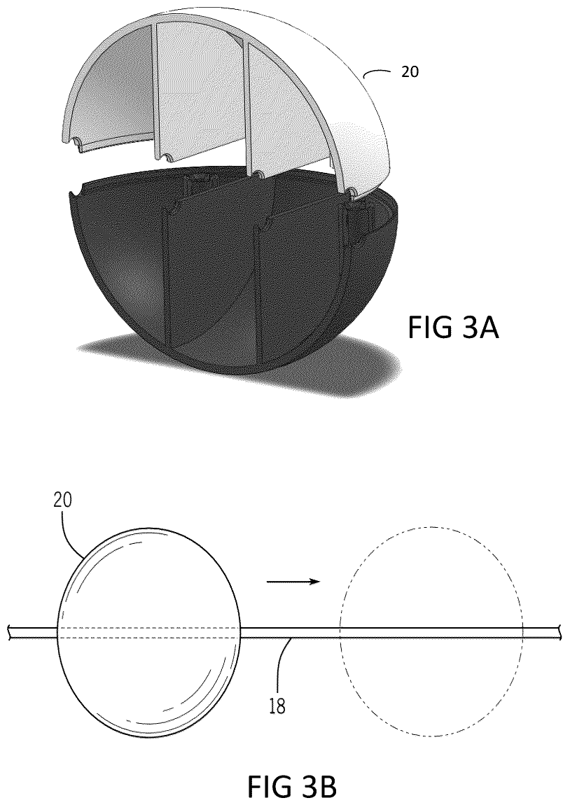

Turning now to FIG. 3A, this figure presents an exploded view of an action ball consistent with certain embodiments of the present invention. In an exemplary embodiment, an action ball 20 may be constructed such that the action ball 20 has a snap connection component and further comprises internal ribbing to maintain the structure. The action ball 20 may be a solid color, such as all blue, or may be composed of multiple colors with sections of the action ball 20 one color while other sections of the action ball 20 may be a different color from the first color. The action ball 20 may split apart to facilitate the placement and replacement of the action balls 20 on the suspension cables (not shown). Each action ball 20 may have a hole of the appropriate diameter through the external skin and internal ribbing to permit the attachment to the suspension cables and passage of the action ball 20 along the suspension cable.

Turning now to FIG. 3B, this figure presents a view of action balls consistent with certain embodiments of the present invention. In an exemplary embodiment, one or more action balls 20 may be placed on a suspension cable 18 by passing the suspension cable 18 through the entire diameter of the action ball 20. This connection form permits each action ball 20 to be slideably moved in either direction along the suspension cable 18.

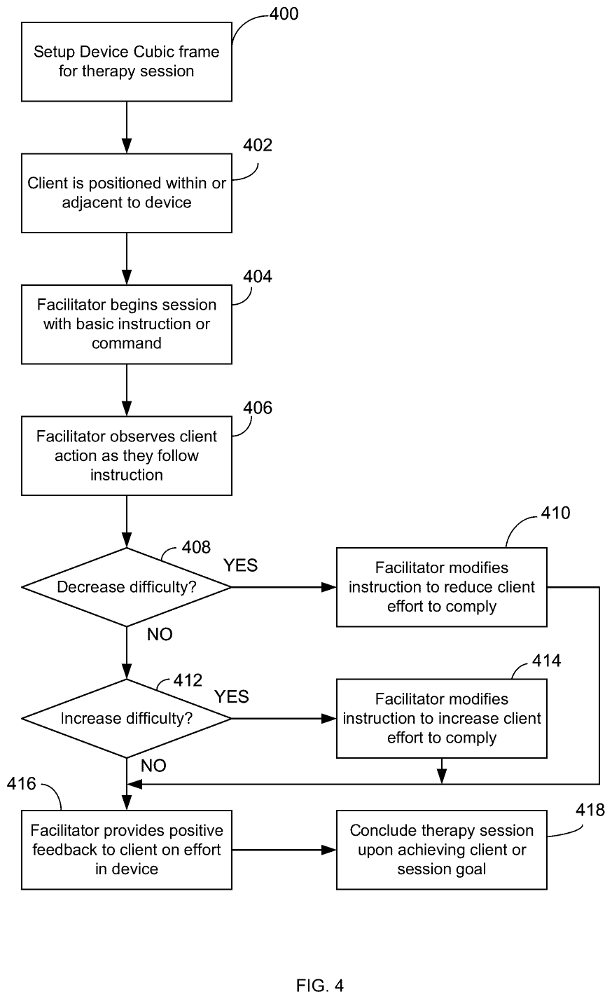

Turning now to FIG. 4, this figure presents an operational flow diagram for EE consistent with certain embodiments of the present invention. In this embodiment, prior to the initiation of a therapy session at 400 the therapist, medical professional, or other facilitator may set up the configuration of the suspension cable and balls within the cubic frame device to assist in achieving the goal, desire, or point of the session. At 402 the client may be positioned within or adjacent to the cubic frame device. At 404 the facilitator may begin the therapy or active session with a basic instruction or command delivered to the client. The facilitator may provide instructions such as “push all yellow balls to the right”, “push down on a blue ball to your right”, “move the red ball to the left”, or other such commands to permit the client to perform actions that are in keeping with achieving the goal, desire, or point of the therapeutic session. Moving balls along any suspension cable and interacting with balls in movement and balls in a nexus contribute to the therapeutic process. At 406 the facilitator observes the client as the client follows the instruction or command that has been given. At 408 if the facilitator discovers through observation that the client is having difficulty following or completing the instruction or command given, the facilitator may choose at 408 to reduce the difficulty level of the instructions or commands given. At 410 the facilitator may modify given instructions or commands to reduce the client effort in following or completing the instruction or command.

If, however, at 412 the facilitator discovers through observation that the client is performing or completing the instructions or commands given easily and with little effort, the facilitator may choose to increase the difficulty level of the instructions or commands given to the client. At 414 the facilitator may modify given instructions or commands to increase the client effort to follow or complete the instruction or command.

Regardless of the level of the instructions or commands being extended to the client, the facilitator at 416 may provide positive feedback in comments such as “you're doing well”, “good job”, or other positive statements to increase the level of effort and comfort of the client during the therapy session. At 418, the facilitator may conclude the session when the facilitator has determined that the client as achieved the pre-configured goal, desire, or point of the therapy session.

While certain illustrative embodiments have been described, it is evident that many alternatives, modifications, permutations and variations will become apparent to those skilled in the art in light of the foregoing description.

What is claimed is:

1. A therapeutic system, comprising:
a device comprising a frame encompassing a volumetric area;
said device further comprising a plurality of suspension cables that cross portions of said cubic volume of said frame;
said suspension cables having one or more balls positioned on said suspension cables;
a user positioned within or adjacent to said device cubic volume;
said user responding to an instruction by interacting with said balls to follow or complete said instruction;
receiving additional instructions to interact with said balls and suspension cables to progress to a pre-established goal;
completing a plurality of instructions for movement and interaction with said frame, balls, and suspension cables and achieving said pre-established goal.

2. The therapeutic system according to claim 1 where said suspension cables are composed of metal, plastic, braided material, or any other material that may be formed into a suspension cable.

3. The therapeutic system according to claim 1 where said balls are positioned within said frame by passing said suspension cables through said balls.

4. The therapeutic system according to claim 1 where said balls are slideably movable along the suspension cable upon which said balls are positioned.

5. The therapeutic system according to claim 1 where instructions to said user are provided by a facilitator.

6. The therapeutic system according to claim 5 where the facilitator observes the user interaction with the balls within the frame and reduces level of effort required in the instruction in reaction to user movement.

7. The therapeutic system according to claim 5 where the facilitator observes the user interaction with the balls within the frame and increases the level of effort required in the instruction in reaction to user movement.

8. The therapeutic system according to claim 1 where said pre-established goal is formulated to achieve a therapeutic effect for said user.

9. A method utilizing a device to provide a therapeutic effect, said method comprising:
a user is positioned within or adjacent to a cubic volume defined by a cubic frame and having a plurality of suspension cables and balls positioned on each suspension cable;
said user establishing a pre-determined goal for interaction with said cubic frame, said suspension cables, and said balls;
said user receiving an initial instruction from a facilitator;
said user following said initial instruction by interacting with said suspension cables and said balls within and adjacent to the cubic frame;
subsequent instructions reactive to said user movement within the cubic frame and interacting with said suspension cables and said balls;
said user receiving subsequent instructions for movement and interaction with said device in furtherance of said pre-determined goal;
said user reaching said pre-determined goal within a session through said movement and interaction and concluding said session upon reaching said pre-determined goal.

10. The method according to claim 9 where the facilitator observes the user interaction with the balls within the frame and reduces the level of effort required in the instruction in reaction to user movement.

11. The method according to claim 9 where the facilitator observes the user interaction with the balls within the frame and increases the level of effort required in the instruction in reaction to user movement.

12. The method according to claim 9 where the facilitator provides positive feedback to the user upon observing user effort in interaction with said device.
